(19) United States
(12) Patent Application Publication
(10) Pub. No.: US 2006/0140086 A1
(43) Pub. Date: Jun. 29, 2006

(54) Optical data write/reproduce device for determining optimum write strategy and writing data according to optimum writ strategy, and method thereof

(75) Inventors: Min-seok Kim, Suwon-si (KR); Yong-jin Ahn, Seoul (KR); Kyung-pil Kang, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/318,617

(22) Filed: Dec. 28, 2005

(30) Foreign Application Priority Data
Dec. 28, 2004 (KR) 10-2004-0114297

(51) Int. Cl. G11B 5/09

(52) U.S. Cl. 369/47.5; 369/59.1

(57) ABSTRACT

An optical write and reproduce device is provided to determine an optimum write strategy from a broader selection of choices. The optical write and reproduce device has an optical pick-up part for emitting a light signal onto an optical disk to write and reproduce data, a memory part for storing thereto at least one write strategy indicating an emission type of the light signal, and a control part for determining write strategies, such as those written on the optical disk, and controlling the optical pick-up part to emit the light signal according to the determined write strategy. The control part can select one write strategy from the group including a write strategy reproduced from the optical disk, a write strategy set for each type of optical disk, a write strategy previously tuned for a same type of optical disk, and a default write strategy. Accordingly, an optimum write strategy for a presently-mounted optical disk can be quickly determined.

### CROSS-REFERENCE TO RELATED APPLICATIONS

This application claims the benefit under 35 U.S.C. § 119(a) of Korean Patent Application No. 10-2004-0114297 filed in the Korean Intellectual Property Office on Dec. 28, 2004, the entire disclosure of which is incorporated herein by reference.

### BACKGROUND OF THE INVENTION

1. Field of the Invention

The present invention relates to an optical data write and reproduce device and a method thereof. More particularly, the present invention relates to an optical write and reproduce device which determines an optimum write strategy and writes data according to the optimum write strategy, and a method thereof.

2. Description of the Related Art

As computer use becomes more widespread, various peripheral devices and elements have also developed to efficiently use computers and improve the functions thereof. Especially, various auxiliary storage media have been developed and widely used which hold the memorized programs or data even if a power supply is cut off to the computer. Examples of such auxiliary storage media generally include magnetic storage media and optical disk storage media. Recently, the use of optical disk storage media has significantly increased because the optical disk storage media have relatively higher memory capacity and it is possible to retrieve information with greater speed.

The optical disk is a recording medium which can write and reproduce data according to an optical method. Examples of an optical disk include CD-ROM (compact disk-ROM) and DVD-ROM (digital versatile disk-ROM) which can only reproduce data, CD-R (CD-recordable) and DVD-R (DVD-recordable) on which data can be written once, and CR-RW (CD-rewritable) and DVD-RW (DVD-rewritable) on which data can be repeatedly written and rewritten.

The optical write and reproduce device emits light signals, for example, laser beams, onto a certain track of the optical disk to form grooves and lands so that data of 1 or 0 can be recorded. The optical write and reproduce device detects reflected light or transmitted light obtained by emitting the light signals onto the optical disk so that data can be reproduced.

The optical disk has various characteristics such as material and thickness characteristics depending on type. However, even the same type of optical disk may have slightly different characteristics. There are approximately 60 kinds of DVD-R types, 20 kinds of DVD-RW types, and 10 kinds of DVD-RAM types. Accordingly, if the optical write and reproduce device writes data onto the various optical disks according to a fixed write strategy, incorrect data may be written. The write strategy is to determine the type of device for emitting the light signal, and more particularly, refers to amplitude and duty of a driving pulse supplied to the light source emitting the light signals. To correctly write data, the optical write and reproduce device may use different write strategies according to the type of optical disk.

To this end, a conventional optical write and reproduce device stores to a firmware, the write strategy set for the various types of optical disks. As the optical disk is mounted, the optical write and reproduce device checks the type of optical disk and reads out the information on the corresponding write strategy from the firmware so as to correctly write the data. If a type of optical disk, of which information is not stored in the firmware, is mounted, data may be correctly written according to a certain default strategy. The default strategy is arbitrarily set to be easily used for a number of various types of optical disks.

The write strategy written on the firmware is set according to each optical disk when developed. Accordingly, as the set write strategy is applied to the general optical write and reproduce devices, it may be difficult to consistently perform the same function as that provided at the time of developing the disk. Additionally, the conventional optical write and reproduce device should select one write strategy from the group including the write strategy stored by the device manufacturer and the default write strategy so that the scope of selection of the write strategy is limited. Therefore, it is difficult to select an optimum write strategy, and the write status of data may become deteriorated.

Accordingly, a need exists for a system and method which can efficiently and effectively determine an optimum write strategy and write data according to the optimum strategy.

### SUMMARY OF THE INVENTION

Accordingly, embodiments of the present invention are provided to address the above and other problems, and provide at least the advantages described below. Therefore, an object of the present invention is to provide an optical write and reproduce device that varies selectable types of write strategy so as to quickly select an optimum write strategy, and a method thereof.

To achieve the above-described and other objects of the present invention, an optical write and reproduce device is provided comprising an optical pick-up part for emitting a light signal onto an optical disk to write and reproduce data, a memory part for storing thereto at least one write strategy indicating an emission type of the light signal, and a control part for determining one of the write strategies written on the optical disk and controlling the optical pick-up part to emit the light signal according to the determined write strategy.

The device may further comprise a write data process part for forming a certain test data, and a reproduce data process part for reproducing data from an RF signal detected from the optical disk. The control part may write the test data on the optical disk according to the determined write strategy, and control the optical pick-up part and the reproduce data process part to reproduce the test data.

The device may further comprise a status detection part for checking a reproduction status of the test data reproduced by the reproduce data process part, and a write strategy tuning part for tuning the determined write strategy based on the reproduction status of the test data.

The memory part may comprise a first memory part for storing thereto the write strategy tuned by the write strategy tuning part, a second memory part for storing thereto a certain default write strategy, and a firmware part for storing thereto a write strategy set for each type of optical disk.

The control part may determine one write strategy from the group including the write strategy reproduced from the optical disk, the write strategy set for each type of optical disk, the write strategy previously tuned for a same type of optical disk, and the default write strategy.

The write strategy tuning part may tune the determined write strategy so that at least one of a BER (bit error rate), an amount of jitter, and the number of detection error of an LPP (land pre-pit) of the reproduced test data reaches a minimum value.

The control part may change the determined write strategy if the reproduction status of the test data does not satisfy the reference condition.

To achieve the above-described and other objects of the present invention, a data write method is provided for an optical write and reproduce device emitting a light signal onto an optical disk to write and reproduce data, the method comprising the steps of (a) determining a write strategy indicating an emission type of the light signal, (b) emitting the light signal onto a test area of the optical disk according to the determined write strategy to write certain test data, (c) reproducing the test data, and (d) if a reproduction status of the test data does not satisfy a certain reference condition, changing the write strategy.

The method may further comprise the steps of (e), where if the reproduction status of the test data satisfies the reference condition, tuning the determined write strategy according to the reproduction status of the test data, and (f) updating the determined write strategy to the tuned write strategy to store it.

The step (e) may be used to tune the determined write strategy so that one of a BER, an amount of jitter, and the number of detection error of an LPP of the reproduced test data reaches a minimum value.

The step (a) may be used to determine one write strategy from the group including the write strategy reproduced from the optical disk, the write strategy set for each type of optical disk, the write strategy previously tuned for a same type of optical disk, and a certain default write strategy.

To achieve the above-described and other objects of the present invention, a data write method is provided for an optical write and reproduce device emitting a light signal onto an optical disk to write and reproduce data, the method comprising the steps of, where if information on a write strategy indicating an emission type of the light signal is reproduced from the optical disk, writing a first test data on the optical disk according to the reproduced write strategy and reproducing the first test data written on the optical disk. The method further comprises the steps of, where if a reproduction status of the first test data does not satisfy a certain reference condition, checking a first write strategy corresponding to a type of the optical disk from a memory holding a write strategy set for each type of optical disk, and changing the write strategy to the first write strategy.

The method may further comprise the step of, where if the reproduction status of the first test data satisfies the reference condition, tuning the write strategy according to the reproduction status of the first test data.

The method may further comprise the steps of writing second test data onto the optical disk according to the first write strategy, checking a reproduction status of the second test data written on the optical disk, and if the reproduction status of the second test data does not satisfy the reference condition, changing the first write strategy to a second write strategy which is previously tuned for a same type of optical disk.

The method may further comprise the step of, where if the reproduction status of the second test data satisfies the reference condition, tuning the first write strategy according to the reproduction status of the second test data.

The method may further comprise the steps of writing third test data onto the optical disk according to the second write strategy, checking a reproduction status of the third test data written on the optical disk, and if the reproduction status of the third test data does not satisfy the reference condition, changing the second write strategy to a certain default write strategy.

The method may further comprise the step of, where if the reproduction status of the third test data satisfies the reference condition, tuning the second write strategy according to the reproduction status of the third test data.

The reproduction status of the first, second, and third test data may be checked by detecting at least one of a BER, an amount of jitter, and the number of detection error of an LPP.

### BRIEF DESCRIPTION OF THE DRAWINGS

The above aspects and features of the present invention will become more apparent by describing certain embodiments of the present invention with reference to the accompanying drawings, in which:

FIG. 1 is a block diagram of an exemplary optical write and reproduce device according to an embodiment of the present invention;

FIG. 2 is a block diagram of an exemplary optical write and reproduce device according to another embodiment of the present invention;

FIG. 3 is a graph for illustrating an exemplary process of tuning a write strategy according to a reproduction status of test data according to an embodiment of the present invention;

FIG. 4 is a flowchart of an exemplary data write strategy of an optical write and reproduce device according to an embodiment of the present invention;

FIG. 5 is a flowchart of an exemplary data write strategy of an optical write and reproduce device according to another embodiment of the present invention; and

FIG. 6 is a flowchart for illustrating an exemplary process of tuning a write strategy according to a reproduction status of test data according to an embodiment of the present invention.

Throughout the drawings, like reference numerals will be understood to refer to like parts, components and structures.

### DETAILED DESCRIPTION OF THE EXEMPLARY EMBODIMENTS

Exemplary embodiments of the present invention will now be described in detail with reference to the annexed drawings. As noted above, in the drawings, the same elements are denoted by the same reference numerals throughout the drawings. In the following description, detailed descriptions of known functions and configurations incorporated herein have been omitted for conciseness and clarity.

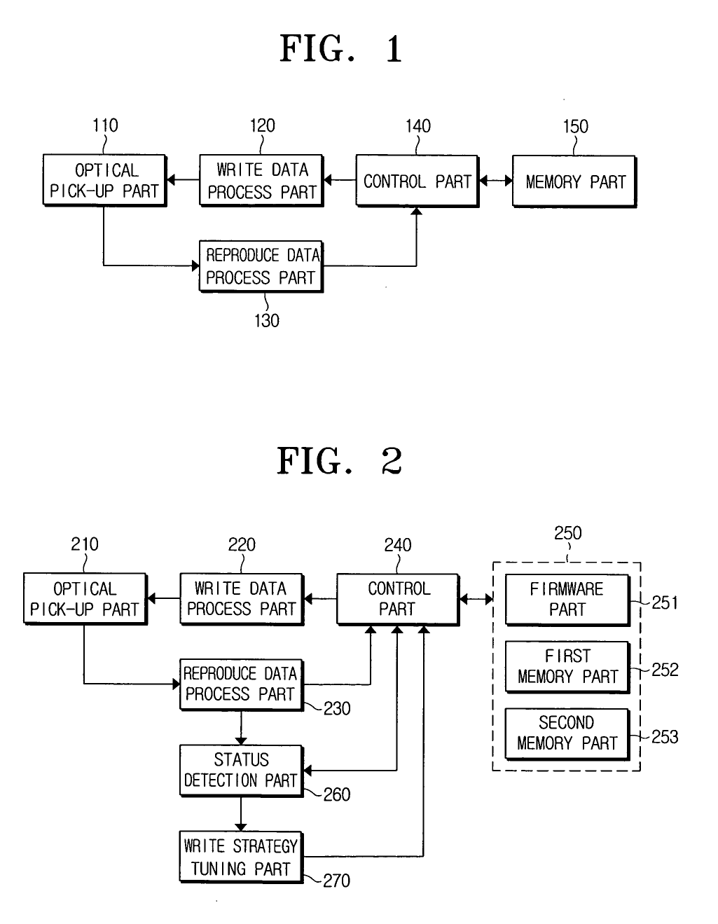

FIG. 1 is a block diagram of an exemplary optical write and reproduce device according to an embodiment of the present invention. Referring to FIG. 1, the optical write and reproduce device comprises an optical pick-up part 110, a write data process part 120, a reproduce data process part 130, a control part 140, and a memory part 150.

The optical pick-up part 110 emits light signals onto an optical disk to write or reproduce data. The surface of an optical disk is separated into a groove track and a land track. Pits are formed on the groove track, and the land track is formed between each groove track to prevent crosstalk between each adjacent groove track. The optical pick-up part 110 emits light signals onto the groove track to form pits and to write data of 0 or 1. When reproducing data, the optical pick-up part 110 emits light signals onto the groove track to reproduce high-frequency signals corresponding to the pits.

The optical pick-up part 110 comprises a laser diode and a driving part (not shown) driving the laser diode. The driving part supplies the laser diode with the driving pulse signal having amplitude and duty set according to a certain write strategy. The laser diode emits light signals corresponding to the driving pulse signal. The emission types of light signals, that is, magnitude and emission time of the light signals, are set according to the write strategy.

The write data process part 120 converts data to be written onto the optical disk into a certain write pattern. The optical pick-up part 110 then emits light signals according to the converted write pattern to form pits so that data can be written.

The reproduce data process part 130 reproduces data written on the optical disk. As the optical pick-up part 110 emits light signals onto the optical disk, the light signals are reflected by pits and detected in a certain RF signal form. The reproduce data process part 130 reproduces data from these detected RF signals.

The control part 140 determines a write strategy for an optical disk. The source of the write strategy, which can be determined by the control part 140, may be the optical disk itself or the memory part 150. For example, the optical disk manufacturer may write data on the optimum write strategy in a certain area of the optical disk. Particularly, the data may be written on the land track of a DVD-R/RW in a form of LPP (land pre-pit), and the data may be written on the control data zone of a DVD-RAM. As data on the write strategy is reproduced from the optical disk, the control part 140 may directly use the data.

The write strategy that can be selected by the control part 140 may also be stored to and retrieved from the memory part 150. Firstly, the manufacturer of the optical write and reproduce device may set the write strategy for each type of optical disk to store it to the memory part 150. That is, the device manufacturer may preset the optimum write strategy according to the medium type and manufacturer of each optical disk during the process of manufacturing it so as to store the optimum write strategy to the optical write and reproduce device itself. The write strategy may be stored to the firmware based on the optical disk characteristics. Therefore, as an ID of the optical disk is checked from the data reproduced by the reproduce data process part 130, the control part 140 can read out the corresponding write strategy from the firmware.

Secondly, if the same type of optical disk as the presently-mounted disk is subsequently mounted and the write strategy applied to the optical disk has been stored to the memory part 150, the stored write strategy can be used.

Thirdly, a certain default write strategy may be stored to the memory part 150, which can be applied to any general optical disk.

As described above, the control part 140 may select one write strategy from the group including the write strategy written on the optical disk, the write strategy preset for each type of optical disk by the device manufacturer, the write strategy previously used for the same type of optical disk, and the default write strategy. Accordingly, the write strategy that can be selected can be varied so that the optimum write strategy for each characteristic of the optical disk can be selected.

FIG. 2 is a block diagram of an exemplary optical write and reproduce device according to another embodiment of the present invention. Referring to FIG. 2, the optical write and reproduce device comprises an optical pick-up part 210, a write data process part 220, a reproduce data process part 230, a control part 240, a memory part 250, a status detection part 260, and a write strategy tuning part 270.

The control part 240 may select one write strategy from the group of various kinds of write strategies as described above. To this end, the memory part 250 comprises a firmware part 251, a first memory part 252, and a second memory part 253.

The firmware part 251 comprises a memory area to which the write strategy set for each type of optical disk by the device manufacturer is stored.

The first memory part 252 comprises a memory area to which the write strategy that has been applied to the same type of optical disk is stored. As the write strategy is tuned according to characteristics of the presently-mounted optical disk, the write strategy of the first memory part 252 is updated to the tuned write strategy. Accordingly, as the same type of optical disk is subsequently mounted, data may be written on it according to the tuned write strategy.

The second memory part 253 comprises a memory area to which the default write strategy is stored. The default write strategy may be set by the device manufacturer at the time of developing the device or may be stored and changed as desired by a user.

The optimum write strategy may be changed slightly even for the same type of optical disk due to errors generated in the process of manufacturing each of the optical disks and the optical write and reproduce device. Accordingly, although the write strategy is determined to be the optimum one for the optical disk, the write strategy may be tuned minutely to meet the optimum write strategy.

To tune the write strategy, the control part 240 controls the write data process part 220 to write certain test data. The test data is arbitrary data for testing reproduction performance of the optical disk. The control part 240 controls the optical pick-up part 210 to write the test data onto a test area of the optical disk according to the determined write strategy. The test area of a DVD-R and a DVD-RW may be a PCA (power calibration area), and the test area of a DVD-RAM may be a DTZ (drive test zone), but is not limited thereto.

The control part 240 then controls the optical pick-up part 210 to emit light signals onto the test area. Accordingly, as the RF signal corresponding to the test data written on the test area is detected, the reproduce data process part 230 reproduces the test data from the RF signal.

The status detection part 260 detects a reproduction status of the data reproduced by the reproduce data process part 230. The reproduction status may be indicated as an error status index. The error status index may be a BER (bit error rate), an amount of jitter, and a number of detection error of LPP.

The BER refers to a correlation between the test data written by the write data process part 220 and the test data reproduced by the reproduce data process part 230, that is, an error rate. When the BER reaches a minimum value, the correlation between the data for writing and the reproduced data is at a maximum value.

The jitter refers to a phase in which shaking or trembling of the pulse of data signals reproduced in the write medium results in a lack of synchronization. If, for example, the data is written according to a C/D (clock to data), the status detection part 260 checks whether the write mark of clock signal and the write mark of data signal are identical, so that the jitter amount can be calculated.

The LPP is pits formed on the land track of the optical disk for the optical write and reproduce device to read the track address. If the number of detection error of LPP, in which the LPP is abnormally detected, is over a certain value, it is determined that the reproduction status is inferior.

The write strategy tuning part 270 reflects the reproduction status detected by the status detection part 260 to tune the write strategy. That is, the optical pick-up part 210 adjusts at least one of the amplitude and duty of the driving pulse signal within a certain range so that the reproduction status reaches an optimum status.

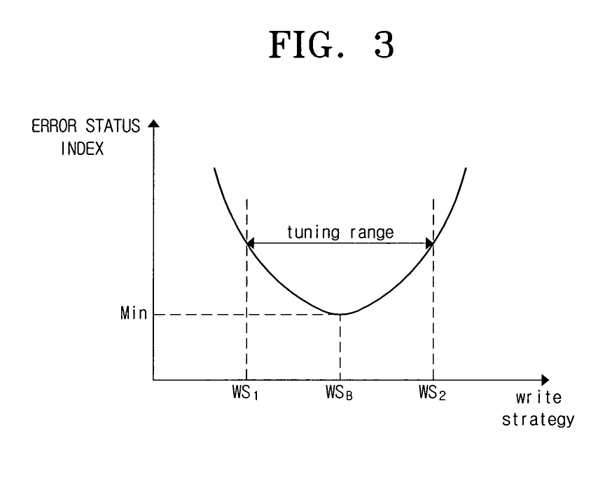

FIG. 3 is a graph for illustrating an exemplary process of tuning the write strategy according to the error status index according to an embodiment of the present invention. The write strategy tuning part 270 sequentially adjusts the write strategy within the tuning range WS1˜WS2 of the presently-determined write strategy to measure the error status index. The error status index may be one or more of the BER, jitter, and the number of error detection of LPP. As the measurement of error status index for the tuning range WS1˜WS2 is completed, the write strategy is set to WS_{B} in which the error status index reaches a minimum value Min. FIG. 3 depicts a write strategy without separation of the amplitude and duty of the driving pulse signal; however, in other embodiments of the present invention, the amplitude and the duty of the driving pulse signal can be separately tuned. In still other embodiments of the present invention, the error status index may be checked while the amplitude and the duty are simultaneously tuned.

Returning to FIG. 2, the control part 240 determines if the reproduction status detected by the status detection part 260 does not satisfy a certain reference condition. The control part 240 determines that the reproduction status does not satisfy the reference condition if the error status index exceeds the reference value. If the reproduction status does not satisfy the reference condition, sufficient write performance can not be obtained even though the write strategy is tuned. Therefore, in this case it may be preferable that the write strategy itself is changed. At this time, one of the above-mentioned four write strategies may be selected.

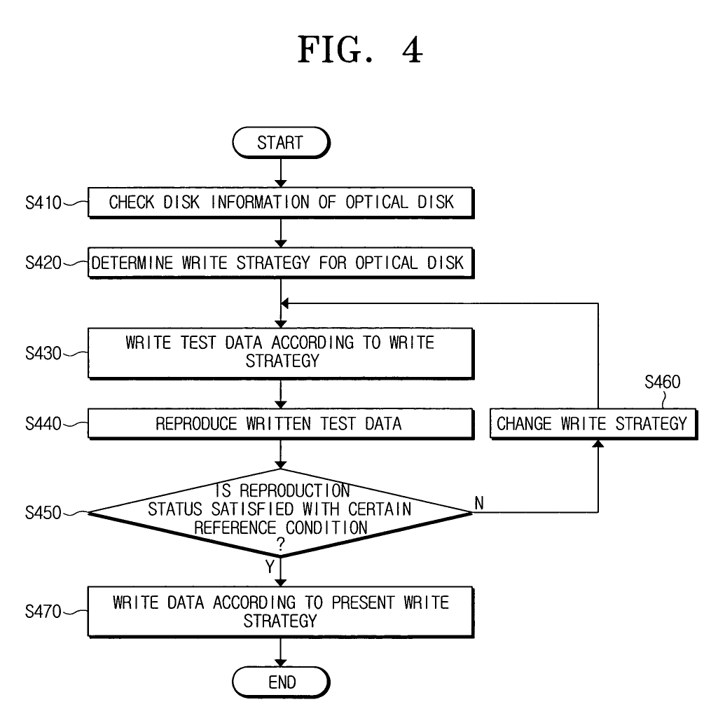

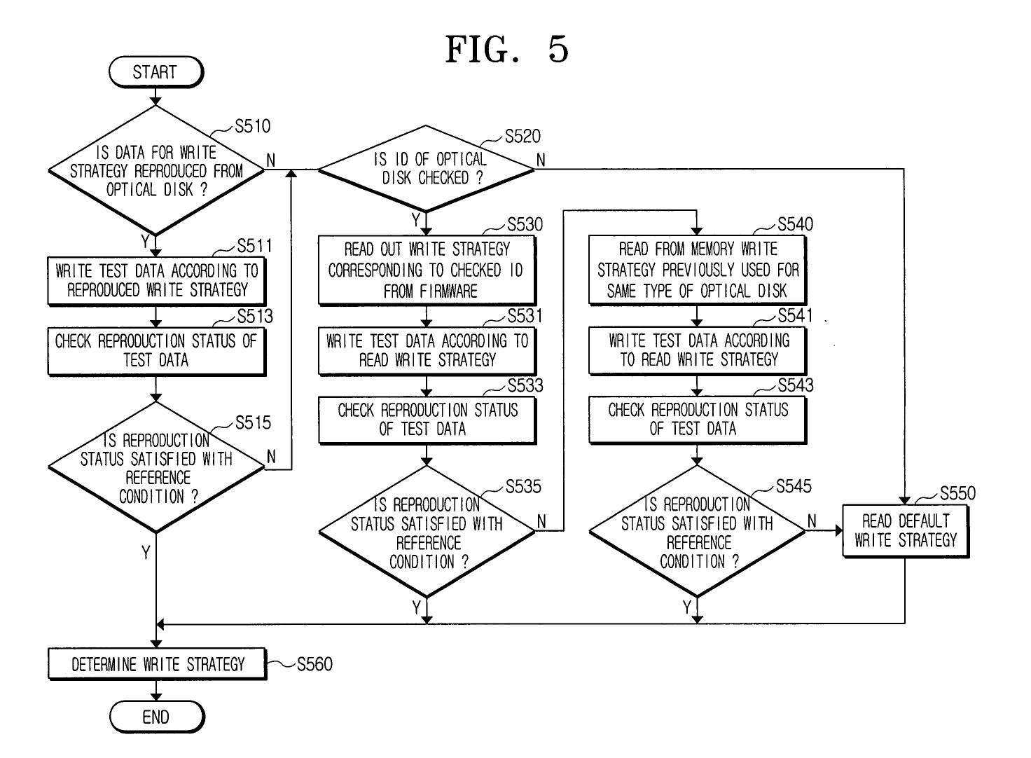

FIG. 4 is a flowchart of an exemplary data write method of an optical write and reproduce device according to an embodiment of the present invention. Referring to FIG. 4, a certain information area of the optical disk is reproduced to check the disk information of the optical disk at step (S410).

According to the checked disk information, a proper write strategy is determined at step (S420). At this time, one write strategy from the group including a write strategy written on the optical disk itself, a write strategy set for each type of optical disk, a write strategy previously used for the same type of optical disk, and a default write strategy may be selected.

The test data is written according to the determined write strategy at step (S430), and the written test data is reproduced at step (S440).

The reproduction status of the test data is checked to determine if the reproduction status satisfies the certain reference condition at step (S450). As described above, step (S450) can be performed based on the determination as to whether the error status index exceeds the certain reference value.

If it is determined that the error status index does not satisfy the reference condition, the write strategy is changed to another one at step (S460).

If it is determined that the error status index satisfies the reference condition, the present write strategy is selected and data is written according to the present write strategy at step (S470).

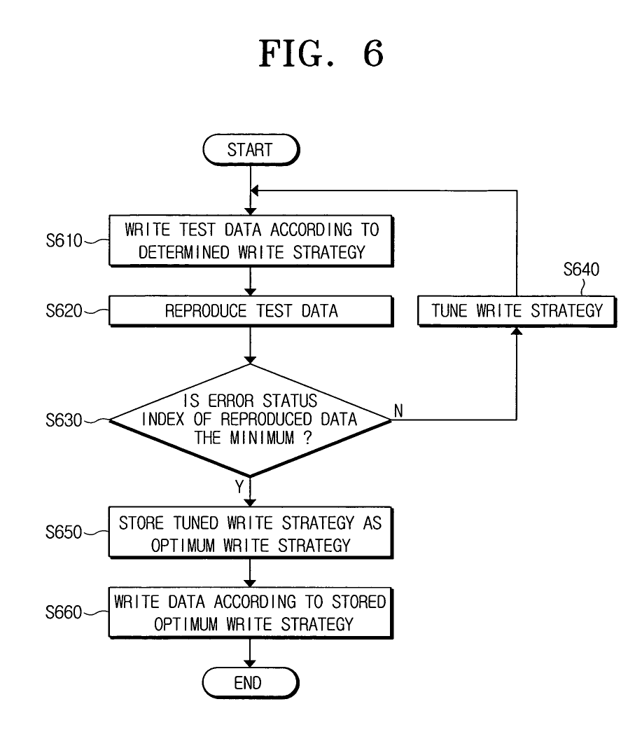

Preferably, even if the error status index satisfies the reference condition, the present write strategy may further be tuned to even more closely provide the optimum status. FIG. 6 is the detailed flowchart for tuning the write strategy, and therefore, a detailed explanation thereof will be provided below.

FIG. 5 is a flowchart of an exemplary data write method of an optical write and reproduce device according to another embodiment of the present invention. Referring to FIG. 5, it is first determined if the data on the write strategy is reproduced from the optical disk at step (S510).

If the data is reproduced, the test data is written according to the reproduced write strategy at step (S511), and the reproduction status of test data is checked during reproducing at step (S513).

Then, it is determined if the reproduction status of the test data satisfies the certain reference condition at step (S515).

If the reproduction status satisfies the reference condition, the write strategy reproduced by the optical disk is finally selected at step (S560).

If the reproduction status does not satisfy the reference condition, or if the data on the write strategy is not reproduced from the optical disk at step (S510), it is then determined if the ID of the optical disk is checked at step (S520).

If the ID of the optical disk is checked, the write strategy corresponding to the checked ID is read from the memory part 150 or 250 at step (S530).

The test data is written according to the read write strategy at step (S531), and the reproduction status is checked while the test data is reproduced at step (S533). If the checked reproduction status satisfies the reference condition at step (S535), the present write strategy is finally selected at step (S560).

If the checked reproduction status does not satisfy the reference condition, the write strategy previously used for the same type of optical disk is read out from the memory part 150 or 250 at step (S540).

The test data is written according to the read write strategy at step (S541), and the reproduction status is checked while the test data is reproduced at step (S543). If the checked reproduction status satisfies the reference condition at step (S545), the present write strategy is finally selected at step (S560).

If the reproduction status does not satisfy the reference condition even according to the above write strategies, or if the ID of the optical disk is not checked at step (S520), the default write strategy is read out from the memory part 150 or 250 at step (S550) and the default write strategy is finally selected (S560).

Referring to FIG. 5, the write strategy determination is preferably performed in the following order, that is, the write strategy written on the optical disk, then the write strategy written in the firmware by the device manufacturer, then the write strategy previously tuned, and finally the default write strategy. However, this order is merely one embodiment of the present invention, and the present invention is not limited thereto. The determination order may be changed.

FIG. 6 is a flowchart of an exemplary method for tuning the determined write strategy to the optimum status according to an embodiment of the present invention. Referring to FIG. 6, the test data is written according to the determined write strategy at step (S610), and then the test data is reproduced at step (S620).

The error status index of the reproduced test data is checked at step (S630) and the write strategy is sequentially tuned at step (S640) until the error status index reaches a minimum value. The error status index may comprise one or more of the BER, the amount of jitter, and the number of detection error of LPP. The write strategy may be tuned by separately or collectively adjusting the amplitude and the duty of the driving pulse signal.

The write strategy resulting in the minimum error status index is then updated to the optimum write strategy so that the write strategy is stored to the memory part 150 or 250 at step (S650).

The optimum write strategy is finally selected and the data is written according to the selected optimum write strategy at step (S660). Even if any write strategy among the above-described various kinds of write strategies is selected, the tuning process of FIG. 6 can be applied to the write strategy. Accordingly, the optimum write condition for the present-mounted optical disk can be provided.

As described above, if the embodiments of the present invention are applied, the source of write strategy diversifies to quickly select the optimum write strategy for the present-mounted optical disk and to write the data. The selected write strategy is tuned to the optimum status. Therefore, the data write quality can be enhanced.

While the invention has been shown and described with reference to certain embodiments thereof, it will be understood by those skilled in the art that various changes in form and details may be made therein without departing from the spirit and scope of the invention as defined by the appended claims.

What is claimed is:

1. An optical write and reproduce device, comprising:
an optical pick-up part for emitting a light signal onto an optical disk;
a memory part for storing at least one write strategy indicating an emission type of the light signal; and
a control part for determining a write strategy and controlling the optical pick-up part to emit the light signal according to the determined write strategy.

2. The device as claimed in claim 1, further comprising:
a write data process part for forming test data; and
a reproduce data process part for reproducing data from an RF signal detected from the optical disk;
wherein the control part is configured to control the write data process part to write the test data on the optical disk according to the determined write strategy and control the optical pick-up part and the reproduce data process part to reproduce the test data.

3. The device as claimed in claim 2, further comprising:
a status detection part for checking a reproduction status of the test data reproduced by the reproduce data process part; and
a write strategy tuning part for tuning the determined write strategy based on the reproduction status of the test data.

4. The device as claimed in claim 3, wherein the memory part comprises:
a first memory part for storing the write strategy tuned by the write strategy tuning part;
a second memory part for storing a default write strategy; and
a firmware part for storing a write strategy set for each type of optical disk.

5. The device as claimed in claim 4, wherein the control part is configured to determine the write strategy from at least one of a write strategy reproduced from the optical disk, a write strategy set for each type of optical disk, a write strategy previously tuned for a same type of optical disk, and a default write strategy.

6. The device as claimed in claim 5, wherein the write strategy tuning part is configured to tune the determined write strategy so that at least one of a BER (bit error rate), an amount of jitter, and a number of detection error of an LPP (land pre-pit) of the reproduced test data reaches a substantially minimum value.

7. The device as claimed in claim 3, wherein the control part is configured to change the determined write strategy if the reproduction status of the test data does not satisfy a reference condition.

8. A data write method for an optical write and reproduce device emitting a light signal onto an optical disk to write and reproduce data, the method comprising:
(a) determining a write strategy indicating an emission type of the light signal;
(b) emitting the light signal onto a test area of the optical disk according to the determined write strategy to write test data;
(c) reproducing the test data; and
(d) if a reproduction status of the test data does not satisfy a reference condition, changing the write strategy.

9. The method as claimed in claim 8, further comprising:
(e) if the reproduction status of the test data satisfies the reference condition, tuning the determined write strategy according to the reproduction status of the test data; and
(f) updating the determined write strategy to the tuned write strategy.

10. The method as claimed in claim 9, further comprising:
(g) storing the updated determined write strategy.

11. The method as claimed in claim 9, wherein the step (e) comprises tuning the determined write strategy so that at least one of a BER (bit error rate), an amount of jitter, and a number of detection error of an LPP (land pre-pit) of the reproduced test data reaches a substantially minimum value.

12. The method as claimed in claim 11, wherein the step (a) determines the write strategy from at least one of a write strategy reproduced from the optical disk, a write strategy set for each type of optical disk, a write strategy previously tuned for a same type of optical disk, and a default write strategy.

13. A data write method of an optical write and reproduce device emitting a light signal onto an optical disk to write and reproduce data, the method comprising:
if information on a write strategy indicating an emission type of the light signal is reproduced from the optical disk, writing first test data on the optical disk according to the reproduced write strategy;
reproducing the first test data written on the optical disk;
if a reproduction status of the first test data does not satisfy a reference condition, checking a first write strategy corresponding to a type of the optical disk from a memory, wherein the memory stores a write strategy set for each type of optical disk; and
changing the write strategy to the first write strategy.

14. The method as claimed in claim 13, further comprising:
if the reproduction status of the first test data satisfies the reference condition, tuning the write strategy according to the reproduction status of the first test data.

15. The method as claimed in claim 13, further comprising:
writing second test data onto the optical disk according to the first write strategy;
checking a reproduction status of the second test data written on the optical disk; and
if the reproduction status of the second test data does not satisfy the reference condition, changing the first write strategy to a second write strategy which is previously tuned for a same type of optical disk.

16. The method as claimed in claim 15, further comprising:
if the reproduction status of the second test data satisfies the reference condition, tuning the first write strategy according to the reproduction status of the second test data.

17. The method as claimed in claim 15, further comprising:
writing third test data onto the optical disk according to the second write strategy;
checking a reproduction status of the third test data written on the optical disk; and
if the reproduction status of the third test data does not satisfy the reference condition, changing the second write strategy to a default write strategy.

18. The method as claimed in claim 17, further comprising:
if the reproduction status of the third test data satisfies the reference condition, tuning the second write strategy according to the reproduction status of the third test data.

19. The method as claimed in claim 18, wherein the reproduction status of the first, second, and third test data is checked by detecting at least one of a BER (bit error rate), an amount of jitter, and a number of detection error of an LPP (land pre-pit).
